(19) United States
(12) Patent Application Publication
(10) Pub. No.: US 2020/0269547 A1
(43) Pub. Date: Aug. 27, 2020

(54) METALIZED CHANNEL BAG SEALABLE BY LOW ENERGY VACUUM SEALERS

(71) Applicant: Tobias Truman, Lewisburg, TN (US)

(72) Inventor: Tobias Truman, Lewisburg, TN (US)

(21) Appl. No.: 16/828,534

(22) Filed: Mar. 24, 2020

Related U.S. Application Data
(60) Provisional application No. 62/796,203, filed on Jan. 24, 2019.

(51) Int. Cl. B32B 15/09; B32B 27/08; B32B 27/32

(52) U.S. Cl. CPC B32B 15/09; B32B 27/08; B32B 2255/10; B32B 2439/70; B32B 27/32

(57) ABSTRACT

Metalized or Mylar channel bags compatible with low power vacuum sealing systems (e.g., FoodSaver) allow existing, low power vacuum sealing devices to provide a longer term (e.g., in excess of 5 years) food storage solution. A metalized channel bag has layers of barrier film, one of which is metalized with a layer of aluminum, which are combined using manufacturing equipment to create bags. At least one set of films is embossed on one side to create vacuum channels.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to U.S. Provisional Patent Application No. 62/796,203 entitled “METALIZED CHANNEL BAG SEALABLE BY LOW ENERGY VACUUM SEALERS” filed on Jan. 24, 2019.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to food storage systems and methods. More particularly, this invention pertains to vacuum sealer food storage systems and compatible consumable bags for use with such vacuum sealers.

Since 1986, Tilia, Inc. has been manufacturing and selling a low power vacuum-packing, heat sealing system to consumers called “FoodSaver”. “FoodSaver” is a registered trademark of Tilia, Inc. used in connection with their line of low power vacuum packing heat sealing systems and compatible accessories and consumables (e.g., plastic channel bags). The FoodSaver system uses specially designed textured channel bags to store foods and liquids. Food to be stored is placed into a polyethylene channel bag (see FIG. 1), the channel bag is inserted into a FoodSaver, the FoodSaver uses vacuum to remove air surrounding the food, and then the FoodSaver heat seals the bag closed. According to Tilia, the use of its FoodSaver (and its channel bags) to vacuum seal food will five-fold extend the life of that food. The FoodSaver system extends the life of stored food by reducing the stored food's exposure to oxygen and external moisture.

FoodSaver compatible bags (see FIG. 1) are made of polyethylene with an outer layer of nylon. Textured embossing on the inside surface of the bag allows the FoodSaver system to draw air out of the bag, while the plastics (i.e., polyethylene and nylon) allow the FoodSaver to heat seal the end of the bag once the vacuum is achieved inside the bag. However, because FoodSaver bags are made primarily of plastics, over time, oxygen and moisture (slowly) penetrate the bag, thereby limiting the food storage time of this system to no more than about 3 years.

Mylar bags (i.e., metalized bags or aluminum-foil based bags) are commonly referred to today as long-term food storage bags. These bags are composed of one or more thin layers of polyester, polyethylene and aluminum foil, as well as other barrier materials. They offer much greater protection from moisture and oxygen intrusion than that offered by standard plastic bags compatible with the FoodSaver system. As used herein, “Mylar” refers not to material formed by stretched polyethylene terephthalate, but the more generic usage of “Mylar” as one or more plastic or polymer substrates fused with a metal layer (e.g., aluminum foil). Mylar bags also offer the advantage of preventing any light intrusion due to the Mylar bag's metal layer. Homesteaders, food “preppers”, and survivalists use aluminum foil-based bags or metallized Mylar bags as a method for greater long-term food storage of their dry goods (e.g., pasta, beans, wheat, rice, etc). However, Mylar bags are not compatible with the FoodSaver system because existing Mylar bags are not textured/channeled to allow the FoodSaver to draw air from the Mylar bag in order to create a vacuum, and the heating element within a FoodSaver device does not create sufficient heat to heat seal existing Mylar bags.

### BRIEF SUMMARY OF THE INVENTION

Aspects of the present invention provide a metalized (Mylar) channel bag compatible with low power (e.g., FoodSaver) type vacuum sealing systems.

The invention of metalized or Mylar channel bags compatible with low power vacuum sealing systems (e.g., FoodSaver) allows existing, low power vacuum sealing devices to provide a longer term (e.g., in excess of 5 years) food storage solution. In one aspect, the invention is three layers of barrier film, one of which is metalized with a layer of powdered aluminum via physical vapor deposition, which are combined using manufacturing equipment to create bags. One set of film is embossed on one side to create vacuum channels. The layers are pre-heated to approximately 80 degrees Celsius and fused together at the side seams by heating the seams to approximately 110 degrees Celsius and pressing the seams at approximately 300 kg/m². The fused material is then converted on a press to create Mylar bags. Because the final storage bag is textured/channeled, it is compatible with the vacuum operation of low power vacuum heat sealing systems (e.g., FoodSaver devices). Additionally, because only a thin layer of metal is deposited onto the bag, the bag remains flexible under the vacuum, and the low power vacuum sealing system can create enough heat at the point of the seal to properly seal the bag at the previously open end of the bag. That is, the metal layer does not disperse the heat quickly enough to prevent sealing of the opposing polyethylene surfaces to one another, yet the thin metal layer is thick enough to prevent air intrusion through the plastic substrate upon which it is vapor deposited.

In one aspect, a metallized channel bag includes a first metallized film section and a second metallized film section. The first metallized film section includes a first layer of polymer, a second layer of polyethylene, and a third layer of metallized polyester. The first, second, and third layers of the first metallized film section are fused to one another. The second metallized film section includes a first layer of polymer, a second layer of polyethylene, and a third layer of metallized polyester. The first, second, and third layers of the second metallized film section are fused to one another. The second metallized film section is at least partially embossed along a central portion of the second metallized film section. The first metallized film section is attached to the second metallized film section to form the bag.

In another aspect, a metallized channel bag includes a first metallized film section, and a second metallized film section. The second metallized film section is at least partially embossed along a central portion of the second metallized film section. The first metallized film section is attached to the second metallized film section to form the bag.

### BRIEF DESCRIPTION OF THE SEVERAL VIEWS OF THE DRAWINGS

FIG. 1 is an image of a prior art polyethylene and nylon channel vacuum bag.

FIG. 2 is an image of a prior art Mylar bag.

FIG. 3 is an image of a channeled Mylar bag.

FIG. 4 is an image of an embossed Mylar bag compatible with low power vacuum heat sealing systems (e.g., FoodSaver systems).

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component. As used herein, the upright position of a storage bag is laying on a level surface such that there is a bottom layer and a top layer forming the bag, and the end or opening is at a longitudinal end of the bag.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

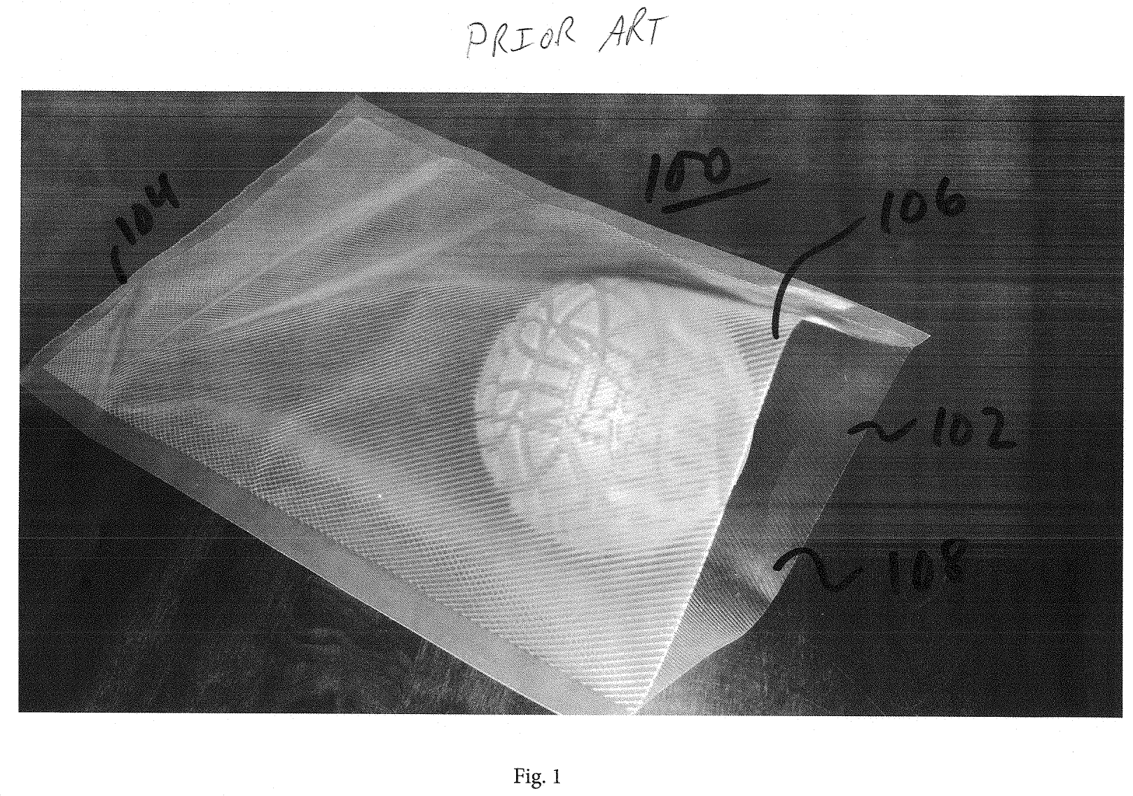

Referring to FIG. 1, a prior art layered polyethylene and nylon channel vacuum bag 100 compatible with low power vacuum sealing systems is shown. Alternatively, the prior art bag 100 may be formed of combinations of plastics including nylon, polyethylene, polypropylene (oriented or non-oriented), polyethylene terephthalate (oriented or non-oriented), cast polypropylene, or other materials. In operation, a long film of plastic is manufactured with textured surface sections 102 on one surface of the film and made into large rolls. The edges of two or more lengths of film (at least one textured) are mated such that the textured section 102 is internal (i.e., faces a smooth surface of the opposing length of film). The large rolls of film are cut to size with hot knives that seam the edges (i.e., sides) of the lengths of film together when cut. Then, the cut and seamed film layers are fed into bag manufacturing machines which cut the lengths of film into individual bags and seal a bottom 104 of each bag. Although variations exist, the material thickness is generally 3-4 mil for the both the smooth side layer 106 and the channel layer 108. However the total thickness of the channel layer is up to 11.5 mil accounting for the channel pattern.

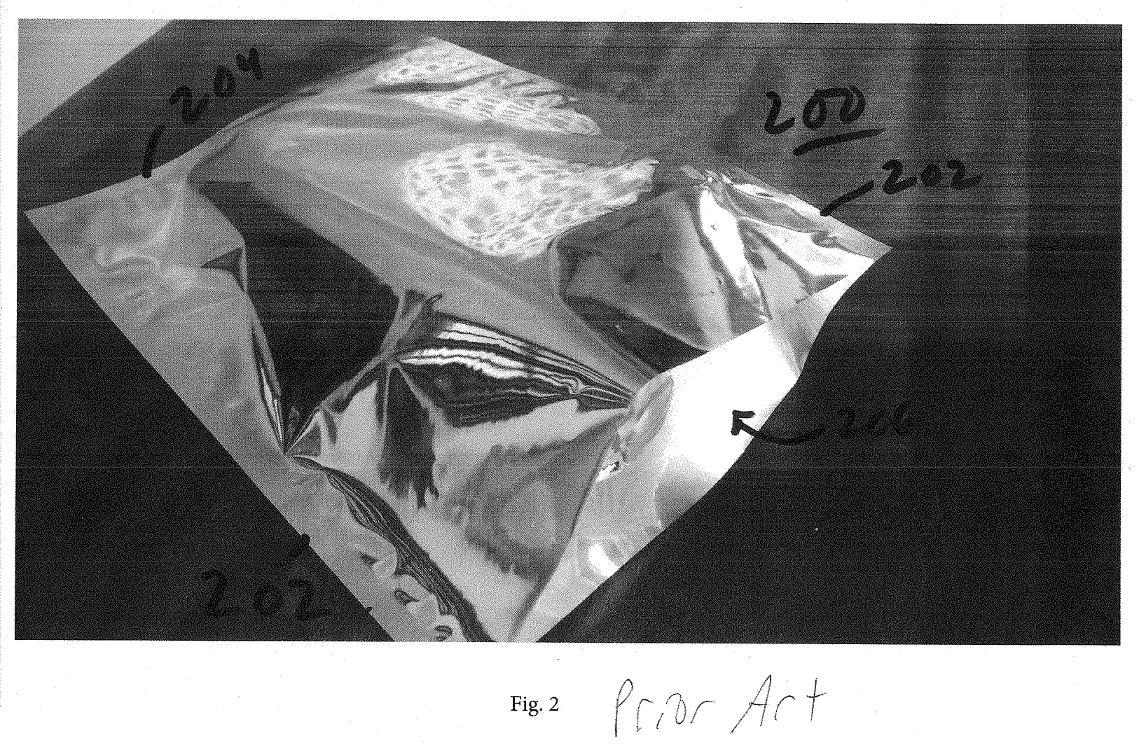

FIG. 2 is an image of a prior art Mylar or metalized bag 200. The bag is formed by depositing metal (e.g., aluminum) on or fusing metal to a plastic substrate and creating rolls of this film. In one embodiment, actual aluminum foil is used as a barrier layer in combination with one or more plastic films. Two or more large rolls of film are layered together and cut to size with hot knives that seam the sides 202 of the lengths of film together when cut. Then, the side fused film layers are fed into bag manufacturing machines where the side fused film layers are cut into individual bags and the bottom seals 204 are formed. These Mylar bags typically range from 2.5 to 7.5 mils thick and have a higher sealing temperature than a polyethylene channel bag. Low power vacuum sealing devices do not create enough heat to reliably seal an open end 206 of the bag 200. Additionally, these bags 200 are smooth such that they do not allow for vacuum (evacuation of air) by any channel vacuum sealing devices. These types of mylar bags 200 are typically sealed by: adding an oxygen absorber to the bag, squeezing as much air as possible out from around product (e.g., a food item such as rice) within the bag 200, and sealing the open end 206 with a high-power heat sealer such as an impulse sealer.

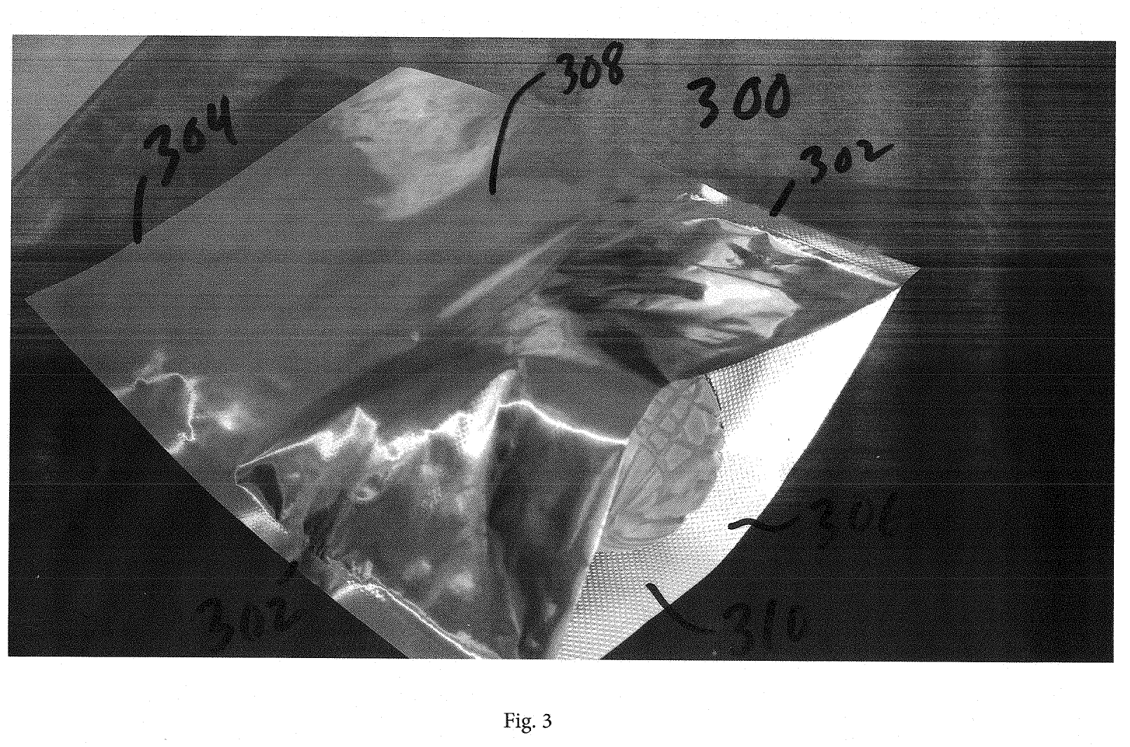

FIG. 3 is an image of a channeled Mylar bag 300 according to one embodiment of the invention. In one embodiment, two or more rolls of film are created using a combination of polyethylene, aluminum foil, Mylar or a similar film such as linear low-density polyethylene (LLDPE). The bag is formed by depositing metal (e.g., aluminum) on or fusing metal to a plastic substrate (e.g., polyethylene or LLDPE) and creating rolls of this film. In one embodiment, actual aluminum foil is used as the film and no metal is fused or deposited thereon. Two or more large rolls of film 308, 310 are layered together and cut to size with hot knives that seam the sides 302 of the lengths of film together when cut. Then, the side fused film layers are fed into bag manufacturing machines where the side fused film layers are cut into individual bags 300 having a first film section 308 and a section film section 310 with a bottom seal 304 formed therebetween. These bags are of similar thickness to smooth Mylar bags (see FIG. 2) but can be vacuumed and sealed with high power vacuum sealers (i.e., commercial vacuum sealers of higher wattage than commonly available FoodSaver systems and the like). The film thickness is approximately 4 mil for each of the first and second film sections 308, 310. Embossments 306 in at least one of the film sections 310 are approximately 8-11 mil offset in different embodiments (i.e., different embossing patterns).

In one embodiment, the metallized channel bag 300 includes a first metallized film section 308, and a second metallized film section 310. The first metallized film section 308 and second metallized film section 310 are generally rectangular. The first metallized film section 308 is attached to the second metallized film section 310 to form the bag 300. In one embodiment, the first metallized film section 308 includes a layer of aluminum fused to a layer of polymer substrate. In one embodiment, the polymer substrate is at least 1 of polyethylene, polyethylene terephthalate, or linear low-density polyethylene. In one embodiment, the first metallized film section 308 includes a layer of polymer substrate having a layer of aluminum vapor deposited thereon. In another embodiment, the first metallized film section 308 includes a layer of aluminum foil. In one embodiment, the second metallized film section 310 has the same layers is the first metallized film section 308. The second metallized film section 310 is at least partially embossed along a central portion 306 of the second metallized film section 310. The film layers described herein are fused to one another via lamination (i.e., controlled application of heat and pressure over a controlled time) or by other suitable adhesive processes. In one embodiment, the first film section 308 is approximately 4 mil thick. In one embodiment, the second film section 310 is approximately 4 mil thick prior to embossment in between 8 and 11 mil thick after embossment in the embossed central portion 306. That is, the embossment has an offset or relief of between 4 and 6 mil.

Each of the first and the second metallized film sections has a pair of opposing sides. A first side of the pair of opposing sides of the first metallized film section 308 is fused to a corresponding first side of the pair of opposing sides of the second metallized film section 310 via hot knife cutting. A second side of the pair of opposing sides of the first metallized film section 308 is fused to a corresponding second side of the pair of opposing sides of the second metallized film section 310 via hot knife cutting. A bottom edge 304 of the first metallized film section 308 is fused to corresponding bottom edge 304 of the second metallized film section via hot knife cutting. The first film section 308 and the second film section 310 are both arranged with the metal facing away from one another. That is, the bag 300 is formed with the metal layers on the exterior of the bag 300.

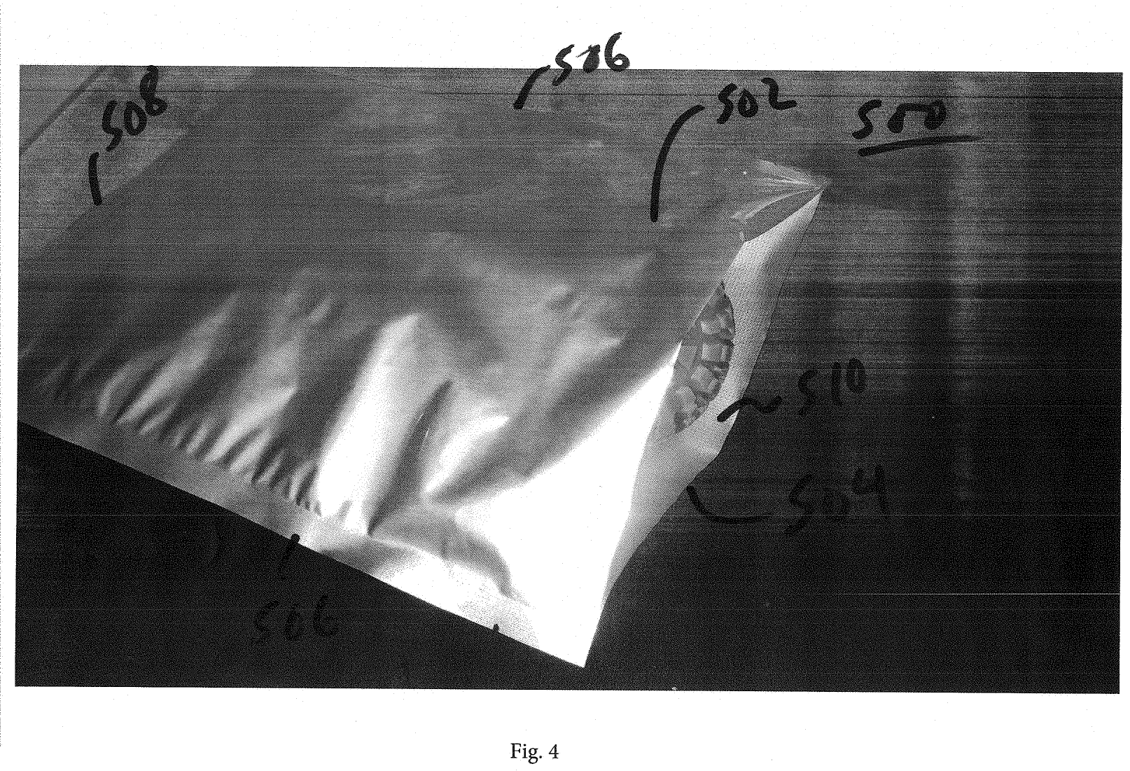

FIG. 4 is an image of a channeled metalized bag 500 compatible with low power vacuum heat sealing systems (e.g., FoodSaver systems) according to one embodiment of the invention. In one embodiment, two rolls of film 502, 504 are created using a combination of nylon or polyester, polyethylene, and metalized polyester (a film created by bonding a layer of powdered aluminum to a polyester substrate). In one embodiment, the thicknesses of the layers of one roll of film 502 are 0.5 mil polyester, 0.5 mil metalized polyester and 3 mil polyethylene, totaling approximately 4 mil in thickness for the film roll portion 502. One roll of the film 504 is then embossed by a high-pressure press at 110 degrees Celsius and 300 kg/m² of pressure. The embossment pattern is approximately 2 mil offset from the surface of the film, but within a range of 1.2 mil to 2.4 mil. The rolls of film 502, 504 are layered together (one embossed and one not embossed) and then cut to size (i.e., width) with hot knives that seam the sides 506 of the rolls together when cut. These seams form the sides 506 of the bags 500. Then, each roll of cut, layered film is fed into bag manufacturing machines where each bag 500 is cut from the roll and a bottom seal 508 of each bag 500 is formed.

In one embodiment, a metallized channel bag 500 includes a first metallized film section 502 and a second metallized film section 504. The first metallized film section 502 includes a first layer of polymer, a second layer of polyethylene, and a third layer of metallized polyester. The first, second, and third layers of the first metallized film section 502 are fused to one another (e.g., laminated). The second metallized film section 504 includes a first layer of polymer, a second layer of polyethylene, and a third layer metallized polyester. The first, second, and third layers of the second metallized film section 504 are fused to one another (e.g., laminated). The second metallized film section 504 is at least partially embossed along a central portion 510 of the second metallized film section 504. The first metallized film section 502 is attached to the second metallized film section 504 to form the bag 500. In one embodiment, the third layers of the first metallized film section 502 and the second metallized film section 504 are formed by vapor depositing aluminum on a polyester substrate. In one embodiment, the first layer of the first metallized film section 502 and the first layer of the second metallized film section 504 are made of at least 1 of polyester or nylon. And what about them, the first metallized film section 502 and the second metallized film section 504 are generally rectangular such that each has a pair of opposing sides. A first side of the pair of opposing sides of the first metallized film section 502 is fused to a corresponding first side of the pair of opposing sides of the second metallized film section 504 via a hot knife cutting process. A second side of the pair of opposing sides of the first metallized film section 502 is fused to a corresponding second side of the pair of opposing sides of the second metallized film section 504 via the hot knife cutting process. A bottom edge of the first metallized film section 502 is fused to a corresponding bottom edge of the second metallized film section 504 via a hot knife cutting process to form the bottom of the bag 500. In one embodiment, a total thickness of the first metallized film section 502 is no more than 4 mil. In one embodiment, an embossment of the embossed central portion 510 of the second metallized film layer 504 has an offset height of between approximately 1.2 and 2.4 mil such that a total thickness of the second film section is between 4.2 mil and 6.4 mil. In one embodiment, the first layer of the first film section 502 is approximately 0.50 mil thick, the second layer of the first film section is approximately 3 mil thick, and the third layer of the first film section 502 is approximately 0.50 mil thick. In one embodiment, prior to embossment, the first layer of the second film section 504 is approximately 0.50 mil thick, the second layer of the second film section 504 is approximately 3 mil thick, and the third layer of the second film section 504 is approximately 0.50 mil thick. In one embodiment, the bag 500 is formed with the third layer of the first metallized film section 502 and the second metallized film section 504 facing away from each other (i.e., on the outside of the bag 500) and with the first layer of the first metallized film section 502 and the first layer of the second metallized film section 504 facing one another (i.e., forming the inside of the bag 500). These reduced layer thicknesses and arrangements enable vacuum sealing of the bag 500 by low power vacuum sealing devices such as residential FoodSaver vacuum sealers.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful METALIZED CHANNEL BAG SEALABLE BY LOW ENERGY VACUUM SEALERS it is not intended that such references be construed as limitations upon the scope of this invention except as set forth in the following claims.

What is claimed is:

1. A metalized channel bag comprising:
a first metalized film section comprising a first layer of polymer, a second layer of polyethylene, and a third layer of metalized polyester, wherein the first, second, and third layers of the first metalized film section are fused to one another; and
a second metalized film section comprising a first layer of polymer, a second layer of polyethylene, and a third layer of metalized polyester, wherein the first, second, and third layers of the second metalized film section are fused to one another, wherein:
the second metalized film section is at least partially embossed along a central portion of the second metalized film section;
the first metalized film section is attached to the second metalized film section to form the bag.

2. The metalized channel bag of claim 1, wherein the third layer of the first metalized film section is formed by vapor depositing aluminum on a polyester substrate.

3. The metalized channel bag of claim 1, wherein the third layer of the second metalized film section is formed by vapor depositing aluminum on a polyester substrate.

4. The metalized channel bag of claim 1, wherein the first layer of the first metalized film section is polyester or nylon.

5. The metalized channel bag of claim 1, wherein the first layer of the second metalized film section is polyester or nylon.

6. The metalized channel bag of claim 1, wherein:
the first metalized film section is generally rectangular;
the first metalized film section has a pair of opposing sides;
the second metalized film section is generally rectangular;
the second metalized film section has a pair of opposing sides;
a first side of the pair of opposing sides of the first metalized film section is fused to a corresponding first side of the pair of opposing sides of the second metalized film section via a hot knife cutting process; and
a second side of the pair of opposing sides of the first metalized film section is fused to a corresponding second side of the pair of opposing sides of the second metalized film section via the hot knife cutting process.

7. The metalized channel bag of claim 1, wherein:
the first metalized film section is generally rectangular;
the first metalized film section has a pair of opposing sides;
the second metalized film section is generally rectangular;
the second metalized film section has a pair of opposing sides;
a first side of the pair of opposing sides of the first metalized film section is fused to a corresponding first side of the pair of opposing sides of the second metalized film section via hot knife cutting;
a second side of the pair of opposing sides of the first metalized film section is fused to a corresponding second side of the pair of opposing sides of the second metalized film section via hot knife cutting; and
a bottom edge of the first metalized film section is fused to a corresponding bottom edge of the second metalized film section via hot knife cutting.

8. The metalized channel bag of claim 1, wherein a total thickness of the first metalized film section is no more than 4 mil.

9. The metalized channel bag of claim 1, wherein an embossment of the embossed central portion of the second film section has an offset height of between approximately 1.2 and 2.4 mil such that a total thickness of the second film section is between 4.2 mil and 6.4 mil.

10. The metalized channel bag of claim 1, wherein:
the first layer of the first film section is approximately 0.50 mil thick;
the second layer of the first film section is approximately 3 mil thick;
the third layer of the first film section is approximately 0.50 mil thick;
prior to embossment, the first layer of the second film section is approximately 0.50 mil thick;
prior to embossment, the second layer of the second film section is approximately 3 mil thick; and
prior to embossment, the third layer of the second film section is approximately 0.50 mil thick.

11. A metalized channel bag comprising:
a first metalized film section; and
a second metalized film section, wherein:
the second metalized film section is at least partially embossed along a central portion of the second metalized film section;
the first metalized film section is attached to the second metalized film section to form the bag.

12. The metalized channel bag of claim 11, wherein the first metalized film section comprises a layer of aluminum fused to a layer of polymer substrate.

13. The metalized channel bag of claim 11, wherein the first metalized film section comprises a layer of aluminum fused to a layer of polymer substrate, wherein the polymer substrate is at least one of polyethylene, polyethylene terephthalate, or linear low-density polyethylene.

14. The metalized channel bag of claim 11, wherein the first metalized film section comprises a layer of polymer substrate having a layer of aluminum vapor deposited thereon.

15. The metalized channel bag of claim 11, wherein:
the first metalized film section is generally rectangular; and
the second metalized film section is generally rectangular.

16. The metalized channel bag of claim 11, wherein:
the first metalized film section is generally rectangular;
the first metalized film section has a pair of opposing sides;
the second metalized film section is generally rectangular;
the second metalized film section has a pair of opposing sides;
a first side of the pair of opposing sides of the first metalized film section is fused to a corresponding first side of the pair of opposing sides of the second metalized film section via a hot knife cutting process; and
a second side of the pair of opposing sides of the first metalized film section is fused to a corresponding second side of the pair of opposing sides of the second metalized film section via the hot knife cutting process.

17. The metalized channel bag of claim 11, wherein:
the first metalized film section is generally rectangular;
the first metalized film section has a pair of opposing sides;
the second metalized film section is generally rectangular;
the second metalized film section has a pair of opposing sides;
a first side of the pair of opposing sides of the first metalized film section is fused to a corresponding first side of the pair of opposing sides of the second metalized film section via hot knife cutting;
a second side of the pair of opposing sides of the first metalized film section is fused to a corresponding second side of the pair of opposing sides of the second metalized film section via hot knife cutting; and
a bottom edge of the first metalized film section is fused to a corresponding bottom edge of the second metalized film section via hot knife cutting.

18. The metalized channel bag of claim 11, wherein the first film section is approximately 4 mil thick.

19. The metalized channel bag of claim 11, wherein the second film section is between 8 and 11 mil thick in the embossed central portion.

20. The metalized channel bag of claim 11, wherein the second film section is approximately 4 mil thick prior to embossment and between 8 and 11 mil thick after embossment in the embossed central portion.
